(19) United States
(12) Patent Application Publication
(10) Pub. No.: US 2025/0370267 A1
(43) Pub. Date: Dec. 4, 2025

(54) OPTICAL SYSTEM, DISPLAY APPARATUS, GLASSES LENS, AND GLASSES

(71) Applicants: Beijing Zitiao Network Technology Co., Ltd., Beijing (CN); LEMON INC., Grand Cayman (KY)

(72) Inventors: Ling FU, Beijing (CN); Xin LI, Beijing (CN); Ziyang ZHANG, Los Angeles, CA (US); Xiaoze OU, Los Angeles, CA (US); Shaopeng ZHU, Beijing (CN); Feiya ZHOU, Beijing (CN); Yan ZHOU, Beijing (CN); Wenbin BAI, Beijing (CN); Xiaokai LI, Beijing (CN)

(21) Appl. No.: 19/228,260

(22) Filed: Jun. 4, 2025

(30) Foreign Application Priority Data
Jun. 4, 2024 (CN) 202410718198.0

(51) Int. Cl. G02B 27/01; G02B 5/30; G02B 17/08

(52) U.S. Cl. CPC G02B 27/0172; G02B 17/0808; G02B 5/3025; G02B 5/3083; G02B 2027/011; G02B 2027/0178

(57) ABSTRACT

An optical system, a display apparatus, a glasses lens, and glasses are provided. The optical system includes a lens assembly, a transflective film, a polarizing reflective layer, a first phase retardation film, and a metasurface. The lens assembly includes a first surface, a second surface, a third surface, and a fourth surface that are sequentially arranged in a direction of an optical axis of the lens assembly. The metasurface is located on a side of the second surface away from the first surface, and the metasurface is located on a light emitting side of the polarizing reflective layer; and the metasurface includes a first area and a second area surrounding at least part of the first area, and a focal power of the first area is less than a focal power of the second area.

### CROSS-REFERENCE TO RELATED APPLICATION

This application claims the priority to and benefits of the Chinese Patent Application No. 202410718198.0, which was filed on Jun. 4, 2024. The aforementioned patent application is hereby incorporated by reference in its entirety.

### TECHNICAL FIELD

At least one embodiment of the present disclosure relates to an optical system, a display apparatus, a glasses lens, and glasses.

### BACKGROUND

Head-mounted display apparatuses play increasingly important roles in fields such as Virtual Reality (VR), Augmented Reality (AR), and Mixed Reality (MR). When a head-mounted display apparatus displays an image, a chromatic aberration directly affects visual experience and immersion of a user.

### SUMMARY

At least one embodiment of the present disclosure provides an optical system, a display apparatus, a glasses lens, and glasses.

At least one embodiment of the present disclosure provides an optical system, including: a lens assembly, including at least two lenses, the at least two lenses include a first surface, a second surface, a third surface, and a fourth surface that are sequentially arranged in a direction of an optical axis of the lens assembly, and the first surface is a convex surface; a transflective film, located on a side of the first surface away from the second surface; a polarizing reflective layer, located on a side of the second surface away from the first surface; and a first phase retardation film, located on a side of the first surface away from the transflective film, the lens assembly further includes a metasurface, the metasurface is located on the side of the second surface away from the first surface, and the metasurface is located on a light emitting side of the polarizing reflective layer; and the metasurface includes a first area and a second area surrounding at least part of the first area, and a focal power of the first area is less than a focal power of the second area.

For example, according to at least one embodiment of the present disclosure, the metasurface includes a liquid crystal layer, and in the liquid crystal layer, a pitch of liquid crystal molecules located in any area of the first area is greater than a pitch of liquid crystal molecules located in any area of the second area.

For example, according to at least one embodiment of the present disclosure, a focal power of the metasurface gradually increases in a direction from a center of the first area to an edge of the first area.

For example, according to at least one embodiment of the present disclosure, the focal power of the first area is 0.

For example, according to at least one embodiment of the present disclosure, the focal power of the metasurface in different areas of the first area is the same, and the focal power of the metasurface in different areas of the second area is the same.

For example, according to at least one embodiment of the present disclosure, the optical axis of the lens assembly runs through the first area.

For example, according to at least one embodiment of the present disclosure, the optical system further includes a linear polarizing film located between the second surface and the third surface, the polarizing reflective layer and the first phase retardation film are both located between the linear polarizing film and the first surface.

For example, according to at least one embodiment of the present disclosure, the optical system further includes a second phase retardation film, located between the linear polarizing film and the metasurface and configured to regulate light incident onto the metasurface.

For example, according to at least one embodiment of the present disclosure, the metasurface is disposed on the fourth surface, the fourth surface is a plane, or an absolute value of a curvature radius of the fourth surface is greater than 100 millimeters.

For example, according to at least one embodiment of the present disclosure, the metasurface is disposed on the third surface, the third surface is a plane, or an absolute value of a curvature radius of the third surface is greater than 100 millimeters.

For example, according to at least one embodiment of the present disclosure, the lens assembly includes a first lens and a second lens; the first lens includes the first surface and the second surface, the second lens includes the third surface and the fourth surface, and the metasurface is disposed on the fourth surface; and the second surface is a concave surface, the third surface is a convex surface or a plane, and there is an air gap between the first lens and the second lens.

For example, according to at least one embodiment of the present disclosure, the optical system includes a first optical assembly and a second optical assembly; the first optical assembly includes the first lens, the transflective film, the polarizing reflective layer, and the first phase retardation film; the second optical assembly includes the second lens and the metasurface; and a ratio of a focal power of the first optical assembly to a focal power of the second optical assembly ranges from 50 to 90.

For example, according to at least one embodiment of the present disclosure, the lens assembly includes a first lens and a second lens; the first lens includes the first surface and the second surface, the second lens includes the third surface and the fourth surface, and the metasurface is disposed on the fourth surface; the optical system further includes an adhesive layer, the adhesive layer is glued between the second surface and the third surface; and the second surface is a concave surface, the third surface is a convex surface, and the second surface and the third surface have same surface type parameters.

For example, according to at least one embodiment of the present disclosure, the lens assembly includes a first lens, a second lens, and a third lens; the first lens includes the first surface, the second lens includes the second surface, and the third lens includes the third surface and the fourth surface; and the first lens further includes a fifth surface disposed opposite to the first surface, the second lens further includes a sixth surface disposed opposite to the second surface, and the fifth surface is located between the first surface and the sixth surface; and the fifth surface and the sixth surface are both planes, and the first phase retardation film is disposed on one of the fifth surface and the sixth surface.

At least one embodiment of the present disclosure provides a display apparatus, including: a display screen including a display surface; and the optical system according to any one of the foregoing examples, the display surface is located on a side of the first surface away from the second surface, and an orthographic projection of the display surface on the metasurface overlaps the first area.

At least one embodiment of the present disclosure provides a glasses lens, including: a lens body, including a first lens surface and a second lens surface that are disposed opposite to each other in a direction of an optical axis of the lens body; a metasurface, disposed on a side of the second lens surface away from the first lens surface; and a polarizing element, disposed on a light incident side of the metasurface, and configured to regulate a polarization state of light, where the metasurface includes a first area and a second area located on one side of the first area, and a focal power of the metasurface gradually decreases in an arrangement direction of the first area and the second area.

At least one embodiment of the present disclosure provides a glasses lens, including: a lens body, including a first lens surface and a second lens surface that are disposed opposite to each other in a direction of an optical axis of the lens body; a metasurface, disposed on a side of the second lens surface away from the first lens surface; and a polarizing element, disposed on a light incident side of the metasurface, and configured to regulate a polarization state of light, where the focal power of the metasurface in a first direction is different from the focal power of the metasurface in a second direction, where the first direction and the second direction intersect with each other, and are respectively tangential to the second lens surface.

For example, according to at least one embodiment of the present disclosure, the glasses lens further includes a phase retardation film and a linear polarizing film, the phase retardation film and the linear polarizing film are both located on the side of the second lens surface away from the first lens surface, the phase retardation film is located between the linear polarizing film and the metasurface, and the metasurface is located on a light emitting side of the phase retardation film and is configured to regulate light incident onto the metasurface.

At least one embodiment of the present disclosure provides glasses, including the glasses lens according to any one of the foregoing embodiments.

### BRIEF DESCRIPTION OF DRAWINGS

To describe the technical solutions in embodiments of the present disclosure more clearly, the accompanying drawings of the embodiments will be briefly described below. Apparently, the accompanying drawings in the following description only relate to some embodiments of the present disclosure rather than limit the present disclosure.

FIG. 1A to FIG. 1C illustrate schematic diagrams of working principles of a same geometric phase lens under different conditions, respectively;

FIG. 2A is a schematic diagram of a principle of generating a chromatic aberration by a refractive lens;

FIG. 2B is a schematic diagram of a principle of generating a chromatic aberration by a geometric phase lens;

FIG. 3 is a schematic diagram of an optical system according to an example in at least one embodiment of the present disclosure;

FIG. 4A and FIG. 4B are schematic diagrams of metasurfaces according to different examples in at least one embodiment of the present disclosure;

FIG. 5 is a schematic diagram of a liquid crystal layer according to an example in at least one embodiment of the present disclosure;

FIG. 6A is a schematic diagram of a display apparatus according to an example in at least one embodiment of the present disclosure;

FIG. 6B is a schematic diagram of an orthographic projection of a display surface and a first area in the display apparatus shown in FIG. 6A;

FIG. 7A is a diagram of a lateral chromatic aberration of an optical system;

FIG. 7B is a spot diagram of an optical system;

FIG. 8A is a diagram of a lateral chromatic aberration of another optical system;

FIG. 8B is a spot diagram of another optical system;

FIG. 9 is a spot diagram of an optical system according to an example in at least one embodiment of the present disclosure;

FIG. 10 to FIG. 14 are schematic diagrams of optical systems according to different examples in at least one embodiment of the present disclosure;

FIG. 15 is a schematic diagram of a progressive addition lens;

FIG. 16A is a schematic diagram of a glasses lens according to an example in at least one embodiment of the present disclosure;

FIG. 16B is a schematic diagram of a metasurface of the glasses lens shown in FIG. 16A;

FIG. 17A is a schematic cross-sectional view of an eyeball with normal visual acuity;

FIG. 17B is a diagram of an astigmatism test of normal visual acuity;

FIG. 18A is a schematic cross-sectional view of an eyeball with nearsightedness and without astigmatism;

FIG. 18B is a diagram of an astigmatism test with nearsightedness and without astigmatism;

FIG. 19A to FIG. 19D are schematic cross-sectional views of eyeballs with different types of astigmatism;

FIG. 20A to FIG. 20D are diagrams of astigmatism tests of different types of astigmatism;

FIG. 21A to FIG. 21D show astigmatic lenses for correcting different types of astigmatism;

FIG. 22 is a schematic diagram of a glasses lens according to an example in at least one embodiment of the present disclosure;

FIG. 23A to FIG. 23D are schematic diagrams of metasurfaces according to different examples in at least one embodiment of the present disclosure;

FIG. 24 is a schematic diagram of a glasses lens using the metasurface shown in FIG. 23C; and

FIG. 25 is a schematic diagram of glasses according to at least one embodiment of the present disclosure.

### DETAILED DESCRIPTION

To make the objectives, technical solutions, and advantages of embodiments of the present disclosure clearer, the technical solutions of embodiments of the present disclosure will be described clearly and completely below with reference to the accompanying drawings of embodiments of the present disclosure. Apparently, the described embodiments are merely some but not all of embodiments of the present disclosure. Based on the described embodiments of the present disclosure, all other embodiments obtained by those ordinarily skilled in the art without creative efforts fall within the protection scope of the present disclosure.

Unless otherwise defined, technical or scientific terms used in the present disclosure should have the common meaning understood by those ordinarily skilled in the art to which the present disclosure belongs. “First”, “second”, and similar terms used in the present disclosure do not indicate any order, quantity, or importance, but are used only to distinguish between different components. “Include”, “comprise”, and similar terms mean that elements or objects appearing before the terms cover elements or objects listed after the terms and their equivalents, without excluding other elements or objects.

Features such as “perpendicular”, “parallel”, and “same” used in the present disclosure all include features such as “perpendicular”, “parallel”, and “same” in the strict sense, as well as cases including certain errors such as “approximately perpendicular”, “approximately parallel”, and “approximately same”, which take, measurement and errors associated with the measurement of a specific quantity, into account (that is, limitation of a measurement system), and indicate within an acceptable deviation range for a particular value determined by those ordinarily skilled in the art. “Center” in embodiments of the present disclosure may include a position strictly located at a geometric center and a position approximately at the center within a small area around the geometric center. For example, “approximately” can indicate within one or more standard deviations, or within 10% or 5% of the stated value.

A broadband cholesteric liquid crystal polymer lens manufactured by using a cholesteric liquid crystal (CLC) material is a type of Pancharatnam-Berry Lens (PBL), and the broadband cholesteric liquid crystal polymer lens is also referred to as a geometric phase lens (GPL). The main feature of the broadband cholesteric liquid crystal polymer lens is the capability to manipulate, by using continuous change distribution of orientations of liquid crystal molecules in a plane, a polarization state of incident light, to realize focusing or divergence of light beam.

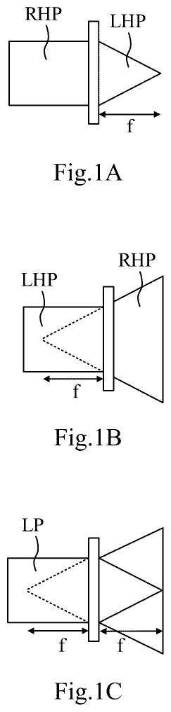

FIG. 1A to FIG. 1C illustrate schematic diagrams of working principles of a same geometric phase lens under different conditions, respectively.

With reference to FIG. 1A, when the incident light is right circularly polarized light RHP, the geometric phase lens has a convergence function, light beams are focused after passing through the geometric phase lens, and a polarization state of emitted light is changed to left circularly polarized light LHP. With reference to FIG. 1B, when the incident light is left circularly polarized light LHP, the geometric phase lens has a divergence function, light beams are diverged after passing through the geometric phase lens, and a polarization state of emitted light is changed to right circularly polarized light RHP. With reference to both FIG. 1A and FIG. 1B, it may be understood that, when circularly polarized light in a particular direction is incident onto a same geometric phase lens, if the geometric phase lens has a convergence function when used in one direction (for example, the circularly polarized light is incident from the left side of FIG. 1A), it has a divergence function when used in a direction opposite to this direction (for example, the circularly polarized light is incident from the right side of FIG. 1A), and the polarization state of the circularly polarized light is changed correspondingly. For example, the right circularly polarized light is changed to the left circularly polarized light, or the left circularly polarized light is changed to the right circularly polarized light. With reference to FIG. 1C, when linearly polarized light LP is incident onto the geometric phase lens, one part of the linearly polarized light LP is changed to the left circularly polarized light, the other part is changed to the right circularly polarized light, and circularly polarized light in different directions can be converged and diverged, respectively.

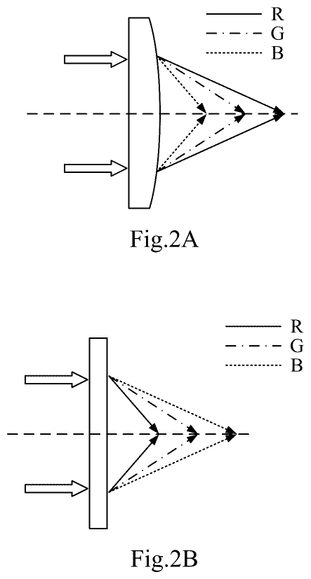

FIG. 2A is a schematic diagram of a principle of generating a chromatic aberration by a refractive lens, and FIG. 2B is a schematic diagram of a principle of generating a chromatic aberration by a geometric phase lens.

Dispersion is a phenomenon that light of different wavelengths is separated due to a difference in refractive indexes of the light when the light passes through a medium (for example, a prism or a lens). In the optical system, this phenomenon causes light of different wavelengths to be focused at different positions, resulting in a chromatic aberration, which makes the imaging blurred or colored edges appear.

With reference to FIG. 2A, the refractive lens causes light of different wavelengths (for example, B light, G light, and R light, where B light is blue light, G light is green light, and R light is red light) to be focused at different positions. A light focus position of light of a short wavelength (for example, B light) is located in front of a light focus position of light of a long wavelength (for example, R light), that is, a positive chromatic aberration is generated. With reference to FIG. 2B, after light of different wavelengths (for example, B light, G light, and R light) pass through the geometric phase lens, the light focus position of light of a long wavelength (for example, R light) is located in front of the light focus position of light of short long wavelength (for example, B light), that is, the geometric phase lens can generate a negative chromatic aberration, so that the geometric phase lens can be configured to compensate for the chromatic aberration generated by the refractive lens. In addition, in comparison with an optical system that eliminates a chromatic aberration by using a combination of different materials with high and low refractive indexes and different dispersion coefficients, it is easier for an optical system that eliminates a chromatic aberration by using a geometric phase lens to ensure a compact structure, so as to make the optical system light and thin.

In researches, the inventor of this application has found that although the geometric phase lens is quite effective in correcting a chromatic aberration of a refractive lens, it is often difficult to balance the chromatic aberration cancellation of the full field of view. Specifically, chromatic aberrations in medium and large field of view can be significantly improved, but chromatic aberrations on an axis and in medium and small fields of view are deteriorated. This is mainly reflected in the decrease of an image point dispersive spot in the large field of view and the increase of image point dispersive spots on the axis and in the small field of view.

The reason for this phenomenon is that dispersion of the refractive lens is directly related to a refraction angle of light, and the refraction angle is positively correlated with a focal power and a refractive index of the refractive lens. Dispersion of the geometric phase lens is determined by a diffraction angle, and a degree of the diffraction angle is positively correlated with a wavelength of light. In other words, because refraction and diffraction generate dispersion by using different mechanisms, capabilities of the two for canceling each other are also different. In a certain sense, a capability of diffraction of generating a dispersion is stronger than that of refraction.

In an optical system in which the chromatic aberration of the refractive lens is eliminated by using a diffractive lens such as the geometric phase lens, if the dispersion generated by the diffractive lens exactly cancels the dispersion generated by the refractive lens in small and medium fields of view, the dispersion generated by diffraction is insufficient to compensate for that generated by refraction in a large field of view. Correspondingly, if the dispersion generated by the diffractive lens exactly cancels the dispersion generated by the refractive lens in the large field of view, the dispersion generated by diffraction will exceed the dispersion generated by refraction in small and medium fields of view. As a result, the two results both result in that the diffractive lens and the refractive lens cannot cancel each other in the full field of view, making imaging definition decrease.

At least one embodiment of the present disclosure provides an optical system, including: a lens assembly, including at least two lenses, where the at least two lenses include a first surface, a second surface, a third surface, and a fourth surface that are sequentially arranged in a direction of an optical axis of the lens assembly, and the first surface is a convex surface; the third surface and the fourth surface are both located on a side of the second surface away from the first surface, and the third surface is located between the second surface and the fourth surface; a transflective film, located on a side of the first surface away from the second surface; a polarizing reflective layer, located on the side of the second surface away from the first surface; and a first phase retardation film, located on a side of the first surface away from the transflective film, where the lens assembly further includes a metasurface, the metasurface is located on the side of the second surface away from the first surface, and the metasurface is located on a light emitting side of the polarizing reflective layer; and the metasurface includes a first area and a second area surrounding at least part of the first area, and a focal power of the first area is less than a focal power of the second area.

At least one embodiment of the present disclosure provides a display apparatus, including a display screen, including a display surface; and the optical system according to any one of the foregoing examples, where the display surface is located on a side of the first surface away from the second surface, and an orthographic projection of the display surface on the metasurface overlaps the first area.

According to the optical system and the display apparatus provided in at least one embodiment of the present disclosure, a folded optical path can be formed by arranging the polarizing reflective layer, the phase retardation film, and the transflective film, so that the space required between human eyes and the optical system is greatly compressed, and the optical system has a smaller size with a lighter and thinner design. In addition, by providing the metasurface to eliminate a chromatic aberration, it is beneficial to compact structure. In addition, because the metasurface has different focal power in different areas, the optical system can achieve chromatic aberration correction balance in all of a large field of view, a medium field of view, and a small field of view, to improve imaging definition.

At least one embodiment of the present disclosure provides a glasses lens, including: a lens body, including a first lens surface and a second lens surface that are disposed opposite to each other in a direction of an optical axis of the lens body; a metasurface, disposed on the second lens surface, where the metasurface includes a first area and a second area located on one side of the first area, and the focal power of the metasurface gradually increases in a direction from a center of the first area to an edge of the first area.

According to the glasses lens provided in at least one embodiment of the present disclosure, the metasurface is set to have gradually changing focal power, so that a sudden change in image definition can be prevented while requirements of a user for visual clarity to objects at different distances can be met, and an astigmatic area or a blind area does not appear. In addition, by setting the metasurface, an overall thickness of the glasses lens can be lighter and thinner.

At least one embodiment of the present disclosure provides a glasses lens, including: a lens body, including a first lens surface and a second lens surface that are disposed opposite to each other in a direction of an optical axis of the lens body; a metasurface, disposed on the second lens surface, where a focal power of the metasurface in a first direction is different from a focal power of the metasurface in a second direction, where the first direction and the second direction intersect with each other, and are respectively tangential to the second lens surface.

According to the glasses lens provided in at least one embodiment of the present disclosure, the metasurface has different focal power in different directions, to perform accurately correction according to different cases of astigmatism. In addition, by setting the metasurface, an overall thickness of the glasses lens can be lighter and thinner.

At least one embodiment of the present disclosure provides glasses, including the glasses lens according to any one of the foregoing examples.

The following describes the optical system, the display apparatus, the glasses lens, and the glasses by using some embodiments with reference to the accompanying drawings.

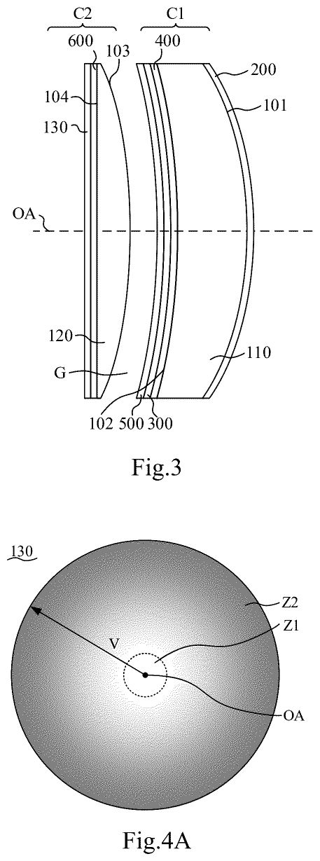

FIG. 3 is a schematic diagram of an optical system according to an example in at least one embodiment of the present disclosure.

With reference to FIG. 3, the optical system includes a lens assembly 100, a transflective film 200, a polarizing reflective layer 300, and a first phase retardation film 400. The lens assembly 100 includes at least two lenses, where the at least two lenses include a first surface 101, a second surface 102, a third surface 103, and a fourth surface 104 that are sequentially arranged in a direction of an optical axis OA of the lens assembly 100, and the first surface 101 is a convex surface. For example, FIG. 3 schematically shows two lenses. The first surface 101 and the second surface 102 may be two opposite surfaces of a same lens (for example, the first lens 110 shown in FIG. 3), and the third surface 103 and the fourth surface 104 may be two opposite surfaces of a same lens (for example, the second lens 120 shown in FIG. 3). For example, the third surface 103 and the fourth surface 104 are both located on a side of the second surface 102 away from the first surface 101, and the third surface 103 is located between the second surface 102 and the fourth surface 104. For example, light may be incident from a side of the first surface 101 away from the second surface 102, and emit from a side of the fourth surface 104 away from the third surface 103.

With reference to FIG. 3, the transflective film 200 is located on the side of the first surface 101 away from the second surface 102. The polarizing reflective layer 300 is located on the side of the second surface 102 away from the first surface 101, and the first phase retardation film 400 is located on a side of the first surface 101 away from the transflective film 200. For example, light incident onto the lens assembly 100 after being transmitted by the transflective film 200 is configured to: reflex between the transflective film 200 and the polarizing reflective layer 300 and emit from the polarizing reflective layer 300, so as to form a folded optical path through the polarizing reflective layer 300, the transflective film 200, and the phase retardation film.

With reference to FIG. 3, for example, the transflective film 200 is located on the first surface 101 that is a convex surface, to facilitate attachment or coating. For example, the transflective film 200 may transmit a part of light and reflect the other part of light. For example, the polarizing reflective layer 300 is configured to: reflect linearly polarized light of one characteristic, and transmit linearly polarized light of the other characteristic. For example, the phase retardation film 400 may be located between the polarizing reflective layer 300 and the first surface 101. For example, the polarizing reflective layer may be a cholesteric liquid crystal layer, and the phase retardation film may be located on a side of the polarizing reflective layer away from the second surface (not shown in the figure). For example, the phase retardation film 400 is configured to enable transmitted light to implement conversion between a circularly polarization state and a linearly polarization state. For example, the phase retardation film 400 may be a quarter-wave plate.

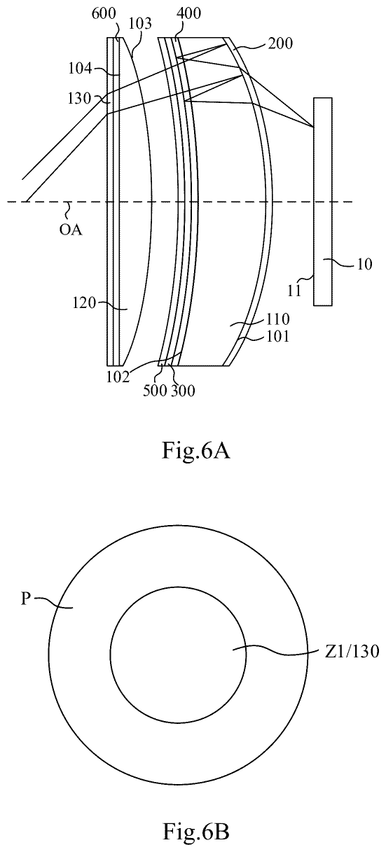

For example, with reference to FIG. 3, when the optical system is used in a display apparatus (for example, the display apparatus shown in FIG. 6A in the following example), a principle of the folded optical path is as follows: A wave plate may be disposed on a light emitting side of a display screen located on the side of the first surface 101 away from the second surface 102, and image light emitted from a display surface of a display screen is converted into right circularly polarized light after passing through the wave plate, and after being transmitted by the transflective film 200, a polarization state of the right circularly polarized light does not change. The light reaches the phase retardation film 400 after being transmitted, and the right circularly polarized light incident onto the phase retardation film 400 is converted into p linearly polarized light, the p linearly polarized light is reflected by the polarizing reflective layer 300 back to the phase retardation film 400. Reflection occurs for the first time herein. Then, the p linearly polarized light is converted into the right circularly polarized light after passing through the phase retardation film 400. The right circularly polarized light reaches the transflective film 200 after being transmitted, and is reflected at the transflective film 200. Reflection occurs for the second time herein. Due to half wave loss, the reflected light is changed from the right circularly polarized light to left circularly polarized light. The left circularly polarized light reaches the phase retardation film 400 after being transmitted, and changes into s linearly polarized light after passing through the phase retardation film 400. Then, the s linearly polarized light is emitted to an emitting pupil, such as a human eye after being transmitted by the polarizing reflective layer 300.

With reference to FIG. 3, the folded optical path may change a polarization state of light propagated between the polarizing reflective layer 300 and the transflective film 200, to realize the folding of light, so that an original focal length of the display apparatus is folded due to, for example, two reflections, increased due to arrangement of the polarizing reflective layer 300, the phase retardation film 400, and the transflective film 200, to greatly compress space required between human eyes and the display apparatus, thereby making the size of the display apparatus smaller, lighter, and thinner.

With reference to FIG. 3, the lens assembly 100 further includes a metasurface 130. The metasurface is, for example, a metasurface of the geometric phase lens. The metasurface is an artificial structure, and can accurately regulate electromagnetic properties (for example, an amplitude, a phase, and a polarization state) of incident light. In the metasurface 130, a non-diffractive phase change may be generated through rotation or by changing geometric arrangement of a micro structure, and by using a geometric phase, it is possible to simplify the design of the metasurface, to implement efficient optical wave manipulation, such as focusing, deflection, and beam splitting. For example, a principle of regulating light by the metasurface may be the same as a principle of regulating light in the related descriptions of FIG. 1A to FIG. 1C.

With reference to FIG. 3, the metasurface 130 is located on the side of the second surface 102 away from the first surface 101. For example, the metasurface 130 may be located between the second surface 102 and the third surface 103. For example, the metasurface 130 may be located on a side of the fourth surface 104 away from the third surface 103. The metasurface 130 is located on a light emitting side of the polarizing reflective layer 300, so that the metasurface 130 can regulate light emitted by the polarizing reflective layer 300.

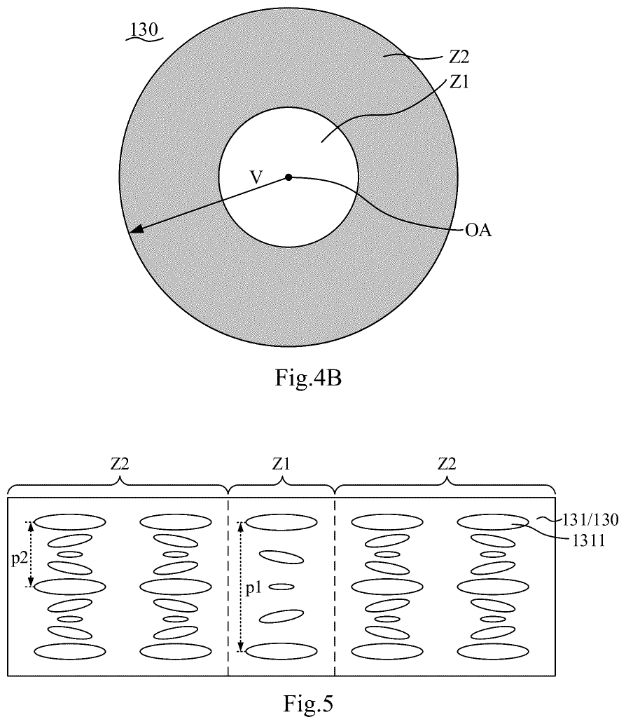

FIG. 4A and FIG. 4B are schematic diagrams of metasurfaces according to different examples in at least one embodiment of the present disclosure. FIG. 4A and FIG. 4B may both be the metasurface in the optical system shown in FIG. 3, but the present disclosure is not limited thereto.

With reference to FIG. 4A and FIG. 4B, the metasurface 130 includes a first area Z1 and a second area Z2 surrounding at least part of the first area Z1. For example, boundaries of the first area Z1 and the second area Z1 are connected. For example, the second area Z2 surrounds the first area Z1 in a circumferential direction. For example, centers of the first area Z1 and the second area Z2 overlap. In some other examples, the second area may alternatively surround one part of the first area, and does not surround the other part of the first area. This is not limited in the present disclosure. For example, sizes, shapes, and relative position relationships of the first area and the second area may all be designed according to an actual situation of the optical system. This is not limited in the present disclosure.

With reference to FIG. 3 to FIG. 4B, the focal power of the first area Z1 is less than the focal power of the second area Z2. By providing the metasurface 130 to eliminate a chromatic aberration, it is beneficial to compact structure. In addition, because the metasurface 130 has different focal power in different areas, the optical system can achieve chromatic aberration correction balance in all of a large field of view, a medium field of view, and a small field of view, to improve imaging definition. For example, the focal power of the first area Z1 is focal power of a structure of the metasurface 130 in the first area Z1, and the focal power of the second area Z2 is focal power of a structure of the metasurface 130 in the second area Z2. For example, when a light beam is incident on the metasurface, light passing through the first area Z1 has a small lateral offset, and light passing through the second area Z2 has a large lateral offset.

With reference to FIG. 3 to FIG. 4B, in some examples, the focal power of the metasurface 130 gradually increases in a direction V from a center of the first area Z1 to an edge of the first area Z1. Because an incident angle of light gradually increases, setting the focal power to gradually increase can better perform chromatic aberration correction on light of different incident angles, so that imaging is clearer. For example, in the direction V from the center of the first area Z1 to the edge of the first area Z1, the focal power of the metasurface 130 gradually increases, and a diffraction capability of the metasurface 130 gradually increases. For example, the first area Z1 has a weak diffraction capability or has no diffraction capability, so that small chromatic aberration correction or no chromatic aberration correction is performed on an area corresponding to the display surface. The area corresponding to the display surface may be an area directly facing the display surface. For example, on a reference surface perpendicular to the direction of the optical axis, an orthographic projection of the display surface overlaps an orthographic projection of the first area.

With reference to FIG. 3 to FIG. 4B, a lateral chromatic aberration of an area not corresponding to the display surface is large. By setting a diffraction capability of the second area Z2 to be stronger than that of the first area Z1, large chromatic aberration correction can be performed on the area not corresponding to the display surface. The area not corresponding to the display surface may be an area not directly facing the display surface. For example, on the reference surface perpendicular to the direction of the optical axis, the orthographic projection of the display surface does not overlap the orthographic projection of the first area. Therefore, after chromatic aberration correction is performed by using the metasurface 130, chromatic aberration cancellation balance between the first area Z1 and the second area Z2 is achieved.

For example, with reference to FIG. 4A and FIG. 4B, when a shape of the first area Z1 is a circle, the direction V from the center of the first area Z1 to the edge of the first area Z1 may be a direction from a center of the circle to a circumference. Certainly, shapes of the first area and the second area may both be circles, or may both be other shapes. Alternatively, the shape of the first area may be different from the shape of the second area, as long as the focal power has a tendency of gradually increasing in the direction from the center to the edge. This is not limited in the present disclosure.

For example, with reference to FIG. 4A, the focal power of the metasurface 130 may continuously change in the direction V from the center of the first area Z1 to the edge of the first area Z1. For example, the focal power of the metasurface 130 may regionally gradually increase in the direction V from the center of the first area Z1 to the edge of the first area Z1. For example, in terms of regionally increasing, two or more areas may be involved. The focal power of the foregoing different areas is different and gradually increases. For example, with reference to FIG. 4B, FIG. 4B schematically shows a case in which the metasurface 130 is divided only into two areas (the first area Z1 and the second area Z2) and does not include another area. The focal power of the first area Z1 is less than the focal power of the second area Z2. For example, the first area may include at least one sub-area, and the second area may include at least one sub-area. The focal power of the at least two sub-areas gradually increases in the direction from the center of the first area to the edge of the first area.

With reference to FIG. 4B, in some examples, the focal power of the first area Z1 is 0. A light incident angle of the optical system in the first area Z1 is small, and a chromatic aberration of light emitted from the first area Z1 may be eliminated only in a manner such as combining materials with different refractive indexes or designing surface type parameters of surfaces, and chromatic aberration correction does not need to be performed by using the first area Z1. For example, a sub-wavelength structure may be disposed only in the second area, and is not disposed in the first area, so that the focal power of the first area is 0, to simplify the manufacturing process. The sub-wavelength structure is, for example, a liquid crystal molecule. Certainly, the sub-wavelength structure may alternatively be a micro-nano structure such as a nano-pillar, and this is not limited in the present disclosure.

For example, in a circumference direction of the metasurface 130, the focal power of different areas is the same. As shown in FIG. 4A, the focal power is substantially consistent in the circumference direction of the metasurface 130, and the focal power changes in the direction V. With reference to FIG. 4B, the focal power of the metasurface 130 at different positions of the first area Z1 is the same, and the focal power of the metasurface 130 at different positions of the second area Z2 is the same. For example, liquid crystal molecules in the first area Z1 are uniformly distributed, and liquid crystal molecules in the annular strip-shaped second area Z2 are uniformly distributed, so that the manufacturing process can be simplified.

FIG. 5 is a schematic diagram of a liquid crystal layer according to an example in at least one embodiment of the present disclosure. FIG. 5 may be a liquid crystal layer in the metasurface shown in FIG. 4B, but the present disclosure is not limited thereto.

With reference to FIG. 5, in some examples, the metasurface 130 includes a liquid crystal layer 131. For example, the liquid crystal layer includes liquid crystal modules in a cholesteric phase with a particular pitch. In the cholesteric phase liquid crystal layer, the liquid crystal molecules are arranged in a layered manner, and have a continuous spiral structure. In a planar texture state, liquid crystal molecules in different planes are respectively arranged in respective planes in parallel, but orientation directions of liquid crystal molecules in adjacent planes change and change spirally in normal directions of the planes.

With reference to FIG. 5, in some examples, in the liquid crystal layer 131, a pitch p1 of liquid crystal molecules 1311 located in any area of the first area Z1 is greater than a pitch p2 of liquid crystal modules 1311 located in any area of the second area Z2. For example, the pitch of the liquid crystal molecules is a distance when an orientation direction of the liquid crystal molecules undergoes a 360° change. For example, with reference to FIG. 4A, pitches of the liquid crystal molecules in the first area and the second area may be inconsistent, and a minimum pitch of the liquid crystal molecules 1311 in the first area Z1 is greater than a maximum pitch of the liquid crystal molecules 1311 in the second area Z2.

When light passes through the liquid crystal layer 131, the liquid crystal molecules 1311 in the cholesteric phase may selectively reflect the incident light (similar to Bragg reflection of crystal). For example, the liquid crystal molecules in the cholesteric phase may reflect an optical wave within a particular wavelength range. A range of the reflected wavelength is related to the pitch of the liquid crystal molecules. To be specific, the range of the reflected wavelength of the liquid crystal molecules may be changed by changing the pitch of the liquid crystal molecules. Therefore, the pitch may be adjusted to control a wavelength and a polarization state of the reflected light. By making the pitch p1 of the liquid crystal molecules 1311 of the first area Z1 greater than the pitch p2 of the liquid crystal molecules 1311 of the second area Z2, the focal power of the second area Z2 can be made larger.

For example, a micro-nano structure may be further disposed in the second area and is not disposed in the first area, so that by arranging the micro-nano structure, the focal power of the first area is less than the focal power of the second area. This is not limited in the present disclosure. For example, the micro-nano structure may be a nano-pillar. By changing a size, a shape, and a deflection angle of the nano-pillar, the focal power of an area in which the micro-nano structure is located is changed.

With reference to FIG. 3 to FIG. 4B, in some examples, the optical axis OA of the lens assembly 100 runs through the first area Z1. For example, the optical system may be used in a coaxially designed display apparatus. The optical axis runs through centers of the lens assembly and the display surface of the display screen, to ensure that the light is directly propagated in the direction of the optical axis. In this way, a light incident angle of light emitted from the display surface is relatively small when incident onto the first area, and a light incident angle of the light when incident onto the second area is relatively large. By setting the focal power of the second area to be larger, light whose light incident angle is large can also be focused at a same position through the regulation of light in the second area, to reduce the chromatic aberration.

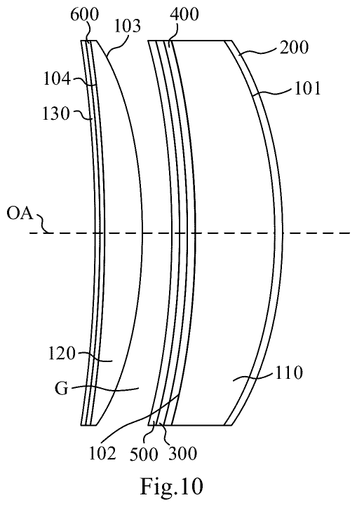

FIG. 6A is a schematic diagram of a display apparatus according to an example in at least one embodiment of the present disclosure. FIG. 6A schematically shows the display apparatus including the optical system shown in FIG. 3. It may be understood that, the display apparatus may alternatively include the optical system shown in FIG. 10 to FIG. 14 in any one of the subsequent examples. This is not limited in the present disclosure. FIG. 6B is a schematic diagram of an orthographic projection of a display surface and a first area in the display apparatus shown in FIG. 6A. FIG. 6B schematically shows only a case in which an orthographic projection of the display surface overlaps the first area. This is not limited in the present disclosure.

As shown in FIG. 6A and FIG. 6B, the display apparatus includes a display screen 10 and an optical system. The display screen 10 includes a display surface 11. The display surface 11 is located on the side of the first surface 101 away from the second surface 102. An orthographic projection P of the display surface 11 on the metasurface 130 overlaps the first area Z1. For example, the orthographic projection P of the display surface 11 on the metasurface 130 may cover the first area Z1, as shown in FIG. 6B. However, the present disclosure is not limited thereto. For example, the orthographic projection of the display surface on the metasurface may be located within a range of the first area. For example, one part of the orthographic projection of the display surface on the metasurface may overlap the first area, and the other part does not overlap the first area. For example, the orthographic projection of the display surface on the metasurface may coincide with the first area.

As shown in FIG. 6A and FIG. 6B, light emitted from the display surface 11 is incident onto the first area Z1 and the second area Z2 at light incident angles with different degrees, and the light incident angle incident onto the first area Z1 is less than the light incident angle incident onto the second area Z2. The light with different incident angles is respectively regulated in the first area Z1 with relatively small focal power and the second area Z2 with relatively large focal power, so that the chromatic aberration of light emitted from different areas on the metasurface 130 can be reduced or eliminated, thereby improving imaging definition.

Certainly, in some off-axis designed display apparatuses, the optical axis of the lens assembly may alternatively not run through the first area, as long as the orthographic projection of the display surface on the metasurface overlaps the first area. This is not limited in the present disclosure.

For example, the display screen may be a silicon-based organic light emitting diode (OLED) display, a liquid crystal display (LCD), a micro light emitting diode (Micro LED) display, or the like.

For example, the display apparatus may be a virtual reality (Virtual Reality, VR) display apparatus. For example, the virtual reality display apparatus may be a display apparatus that uses an ultra-short-focus folded optical path. For example, the display apparatus may be a near-eye display apparatus. The near-eye display apparatus may be a wearable VR helmet, VR glasses, or the like. The present disclosure is not limited thereto.

With reference to FIG. 3 and FIG. 6A, in some examples, the optical system further includes a linear polarizing film 500 located between the second surface 102 and the third surface 103. The polarizing reflective layer 300 and the first phase retardation film 400 are both located between the linear polarizing film 500 and the first surface 101. For example, the linear polarizing film may be a linear polarizer or a polarizer. For example, a transmission axis of the linear polarizing film may coincide with a transmission axis of the polarizing reflective layer. For example, the linear polarizing film may be used to further filter other stray light, allowing only polarized light (for example, the s linearly polarized light) that passes through the linear polarizing film to enter the human eye. For example, the linear polarizing film may be in a three-layer laminated structure, a middle layer in the three-layer laminated structure may be polyvinyl alcohol (PVA) with dichroic molecules added, and at least one layer located on two sides of the middle layer in the three-layer laminated structure may be triacetyl cellulose (TAC).

For example, the optical system may further include an anti-reflective film, to alleviate stray light caused by reflection. For example, the anti-reflective film may be disposed on an interface on which a medium is in contact with air. For example, in the optical system shown in FIG. 3, the anti-reflective film may be disposed on a side of the transflective film 200 away from the first surface 101, the anti-reflective film may be disposed on the third surface 103 and on a surface on one side of the linear polarizing film 500 that faces the third surface 103, and the anti-reflective film may also be disposed on a side of the metasurface 130 away from the fourth surface 104.

With reference to FIG. 3 and FIG. 6A, in some examples, the optical system further includes a second phase retardation film 600, located between the linear polarizing film 500 and the metasurface 130 and configured to regulate light incident onto the metasurface 130. After the linear polarizing film 500 emits linearly polarized light, the linearly polarized light can be converted into circularly polarized light by using the second phase retardation film 600, so that the circularly polarized light enters the metasurface 130 and is emitted after being regulated by the metasurface 130. A polarization state of the circularly polarized light regulated by the metasurface 130 changes. For example, when the circularly polarized light incident onto the metasurface 130 is right circularly polarized light, left circularly polarized light is emitted after being regulated by the metasurface 130. Therefore, the light is first regulated by the second phase retardation film into the circularly polarized light before entering the metasurface, so that a diffraction defect that polarization is incomplete because polarized light that should be originally blocked such as linearly polarized light passes through the metasurface can be avoided, to improve a regulation capability of the optical system for light, thereby avoiding a visual effect similar to “light leakage” such as an insufficient contrast ratio of a display image, and excessive brightness of the background.

For example, the polarizing reflective layer is a cholesteric liquid crystal layer. The first phase retardation film may be located on a side of the polarizing reflective layer away from the second surface, and the metasurface may be located between the linear polarizing film and the first phase retardation film, so that the first phase retardation film can improve the diffraction defect that polarization of the metasurface is incomplete, without additionally providing the second phase retardation film.

For example, when the metasurface is the metasurface 130 whose focal power continuously changes, as shown in FIG. 4A, the second phase retardation film 600 may be correspondingly set to have a continuously changing phase retardation capability, so as to match the metasurface 130. For example, with reference to FIG. 4B, when the metasurface is the metasurface 130 whose focal power regionally changes, the second phase retardation film 600 may be disposed only in an area corresponding to the second area Z2 of the metasurface 130, to match the metasurface 130, and the material of the second phase retardation film 600 can be reduced, to reduce the cost.

In some examples, with reference to FIG. 3, the lens assembly 100 includes a first lens 110 and a second lens 120. The first lens 110 includes the first surface 101 and the second surface 102. The second lens 120 includes the third surface 103 and the fourth surface 104. For example, the second lens 120 may be a convex lens, to increase focal power of the optical system, and reduce a focal length of the optical system, thereby making the structure of the optical system more compact. The metasurface 130 is disposed on the fourth surface 104. For example, the fourth surface 104 may be a plane, to facilitate attachment of the metasurface 130. For example, in combination with some of the foregoing examples, a second phase retardation film may also be disposed between the metasurface and the fourth surface, to avoid a defect that polarization of light is incomplete. In this case, the metasurface may be attached to a side of the second phase retardation film away from the fourth surface.

With reference to FIG. 3, the second surface 102 is a concave surface, the third surface 103 is a convex surface, and there is an air gap G between the first lens 110 and the second lens 120. For example, in some other examples, the third surface may alternatively be a plane. This is not limited in the present disclosure. For example, the air gap G is a gap formed by air. A refractive index of the air gap G is different from that of the first lens 110. For example, the refractive index of air is less than that of the first lens 110, so that a refractive index difference cooperates with the metasurface 130 disposed on the fourth surface 104, to jointly reduce the chromatic aberration. In addition, by providing the air gap G, design freedom of the second surface 102 and the third surface 103 is improved.

In some examples, with reference to FIG. 3, the optical system includes a first optical assembly and a second optical assembly. The first optical assembly C1 includes the first lens 110, the transflective film 200, the polarizing reflective layer 300, and the first phase retardation film 400, to form a reflex architecture to fold the optical path. For example, the first optical assembly C1 may further include a linear polarizing film 500 and an anti-reflective film. The second optical assembly C2 includes the second lens 120 and the metasurface 130, to form a diffraction architecture to compensate for a chromatic aberration generated by the first optical assembly C1. For example, the second optical assembly C2 may further include a second phase retardation film 600 and an anti-reflective film.

In some examples, with reference to FIG. 3, a ratio of a focal power of the first optical assembly C1 to a focal power of the second optical assembly C2 ranges from 50 to 90. For example, the ratio of the focal power of the first optical assembly to the focal power of the second optical assembly ranges from 55 to 85. For example, the ratio of the focal power of the first optical assembly to the focal power of the second optical assembly ranges from 60 to 80. For example, the ratio of the focal power of the first optical assembly to the focal power of the second optical assembly ranges from 65 to 75. For example, the ratio of the focal power of the first optical assembly to the focal power of the second optical assembly is 70. For example, the ratio of the focal power of the first optical assembly C1 to the focal power of the second optical assembly C2 may be set based on chromatic aberration correction on a large field of view.

When a refractive index of air is approximately 1, the focal power is represented as a reciprocal of a focal length. Therefore, with reference to FIG. 3, after the second optical assembly C2 is introduced into the optical system, a focal length change of the optical system caused by the diffraction architecture is less than 1%, and therefore the metasurface 130 barely affects the focal power of the optical system, but can improve the chromatic aberration.

For example, when the optical system is used in the display apparatus (for example, with reference to the display apparatus shown in FIG. 6A), a gaze angle corresponding to the first area is approximately ±5 degrees, a field of view is approximately ±9 degrees or ±10 degrees, and a diameter of the first area is approximately ⅙ of a diameter of the metasurface. It may be understood that, the foregoing values are not constant, and may be adaptively changed according to different optical systems. For example, parameters related to the metasurface may be determined by considering parameters such as a focal power, a magnification, and a field of view in the optical system.

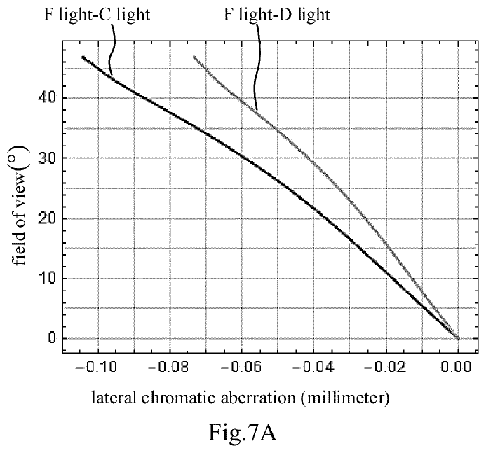

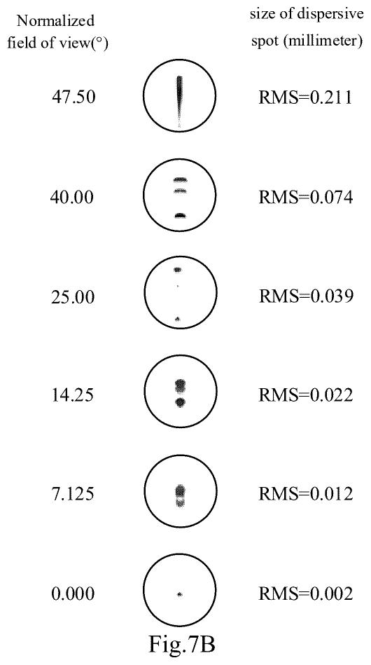

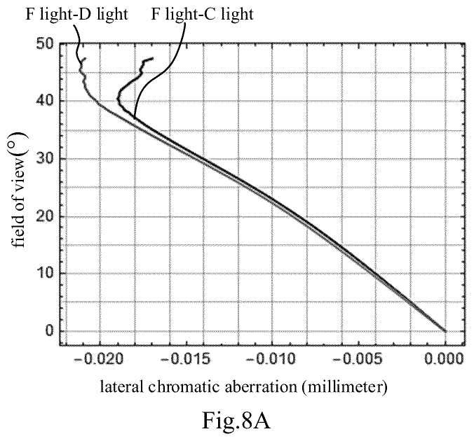

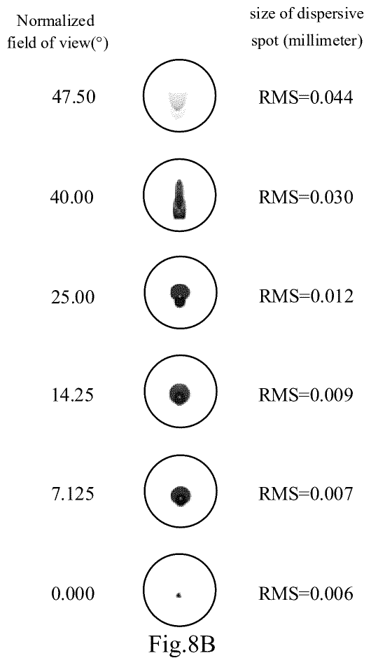

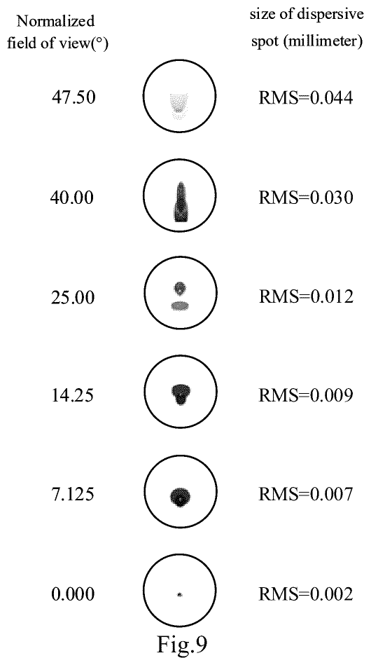

FIG. 7A is a diagram of a lateral chromatic aberration of an optical system; and FIG. 7B is a spot diagram of an optical system. The optical systems corresponding to FIG. 7A and FIG. 7B are the same, and both are two-piece reflex architectures without the metasurface. FIG. 8A is a diagram of a lateral chromatic aberration of another optical system; and FIG. 8B is a spot diagram of another optical system. The optical systems corresponding to FIG. 8A and FIG. 8B are the same, and both are two-piece reflex architectures with the metasurface, and the focal power of the metasurface at different positions is consistent. FIG. 9 is a spot diagram of an optical system according to an example in at least one embodiment of the present disclosure. The metasurface of the optical system corresponding to FIG. 9 is shown in FIG. 4A. The focal power of the metasurface gradually increases in the direction from the center of the first area to the edge of the first area. Lateral chromatic aberration values in a lateral chromatic aberration diagram of the optical system corresponding to the spot diagram shown in FIG. 9 are substantially the same as lateral chromatic aberration values in a lateral chromatic aberration diagram shown in FIG. 8A. The diagrams are omitted herein.

The following describes, through comparison, design results of different optical systems with reference to FIG. 7A to FIG. 9.

In FIG. 7A and FIG. 8A, the lateral chromatic aberration diagram represents a height difference of each wavelength relative to a center wavelength at different image heights of an imaging plane, where a horizontal axis represents a lateral chromatic aberration value of each wavelength relative to the center wavelength, and a vertical axis represents a normalized field of view. In the lateral chromatic aberration diagram, F light is cyan light, C light is red light, D light is yellow light, C light and F light are located on two ends of a human eye sensitive area, and D light is located near a spectral line most sensitive to human eyes.

It can be seen from FIG. 7A that, an absolute value of a lateral chromatic aberration between F light and C light is within 0.105 millimeters, and an absolute value of a lateral chromatic aberration between F light and D light is within 0.08 millimeters. It can be seen from FIG. 8A that, an absolute value of a lateral chromatic aberration between F light and C light is within 0.02 millimeters, and an absolute value of a lateral chromatic aberration between F light and D light is within 0.022 millimeters. It can be learned that, the optical system to which the metasurface 130 is introduced can excellently correct a chromatic aberration of an edge field of view.

In FIG. 7B, FIG. 8B, and FIG. 9, the spot diagram is formed as follows: A lot of light emitted from one point passes through the optical system, and due to an aberration, an intersection point between the light and an image plane no longer focuses on a same point, and forms a dispersive graph dispersed in a certain range. The spot diagram is usually used to evaluate definition of a full field of view of the optical system. Definition of a full field of view refers to imaging definition in the range of the full field of view that can be covered by the peripheral vision when pupils of human eyes are located at entrance pupil positions of an optical axis and gaze at a center of the lens (that is, a zero field of view), and is also referred to as a transient mode.

In the spot diagrams shown in FIG. 7B, FIG. 8B, and FIG. 9, a value in the left vertical direction represents a field of view in a Y direction, and a value of RMS in the right vertical direction represents a root mean square of a diameter from a dispersive dot of a dispersive spot to a centroid of the dispersive spot (or a center of the dispersive spot).

It can be seen from FIG. 7B that, when the field of view in the Y direction is 47.5, the root mean square of the diameter of the dispersive spot is 0.211 millimeters; when the field of view in the Y direction is 25, the root mean square of the diameter of the dispersive spot is 0.039 millimeters; and when the field of view in the Y direction is 0, the root mean square of the diameter of the dispersive spot is 0.002 millimeters. It can be seen from FIG. 8B that, when the field of view in the Y direction is 47.5, the root mean square of the diameter of the dispersive spot is 0.044 millimeters; when the field of view in the Y direction is 25, the root mean square of the diameter of the dispersive spot is 0.012 millimeters; and when the field of view in the Y direction is 0, the root mean square of the diameter of the dispersive spot is 0.006 millimeters. Therefore, after the metasurface whose focal power is uniformly distributed is introduced, the root mean square of the diameter of the dispersive spot in medium and large fields of view (for example, fields of view in the Y direction are 47.5 and 25) decreases, but the root mean square of the diameter of the dispersive spot in a small field of view (for example, the field of view in the Y direction is 0) increases. It can be seen from FIG. 9 that, when the field of view in the Y direction is 47.5, the root mean square of the diameter of the dispersive spot is 0.044 millimeters; when the field of view in the Y direction is 25, the root mean square of the diameter of the dispersive spot is 0.012 millimeters; and when the field of view in the Y direction is 0, the root mean square of the diameter of the dispersive spot decreases to 0.002 millimeters. Therefore, the optical system shown in FIG. 3 provided in the present disclosure can balance chromatic aberration compensation in large, medium, and small fields of view.

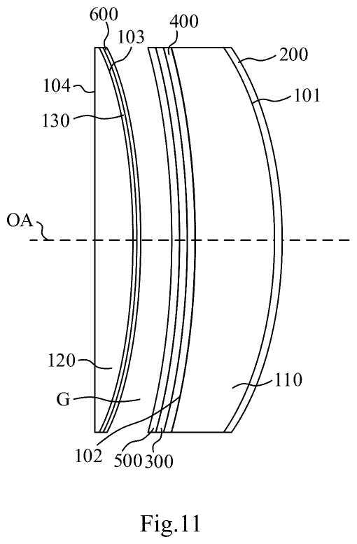

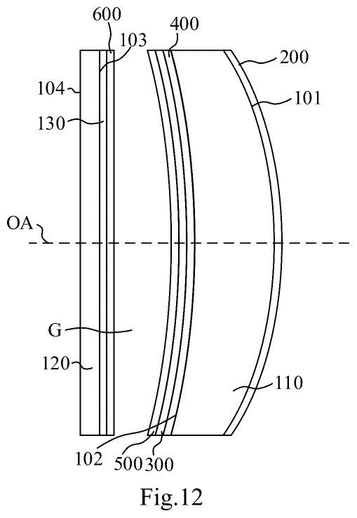

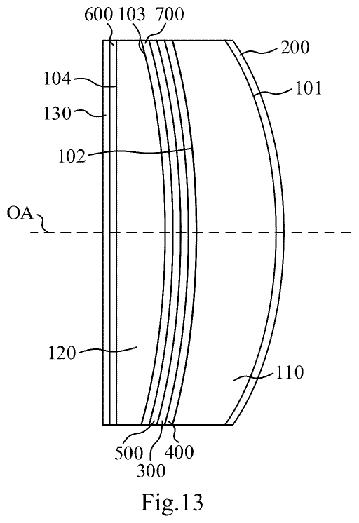

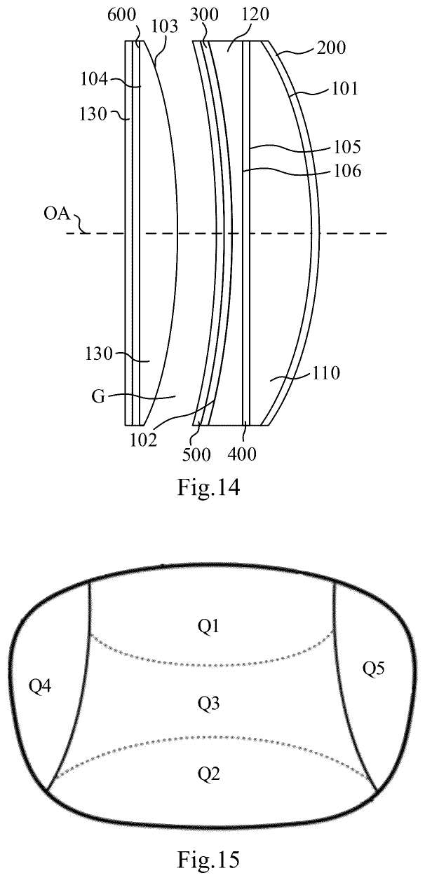

FIG. 10 to FIG. 14 are schematic diagrams of optical systems according to different examples in at least one embodiment of the present disclosure. The optical system shown in FIG. 10 is different from the optical system shown in FIG. 3 in that, the fourth surface 104 in the optical system shown in FIG. 10 is a curved surface rather than a plane. The optical system shown in FIG. 11 is different from the optical system shown in FIG. 3 in that, the metasurface 130 in the optical system shown in FIG. 11 is disposed on the third surface 103 rather than the fourth surface 104. The optical system shown in FIG. 12 is different from the optical system shown in FIG. 11 in that, the third surface 103 in the optical system shown in FIG. 12 is a plane rather than a curved surface. The optical system shown in FIG. 13 is different from the optical system shown in FIG. 3 in that, the first surface 101 and the second surface 102 in the optical system shown in FIG. 13 are respectively two surfaces of different lenses, rather than two surfaces of a same lens. The optical system shown in FIG. 14 is different from the optical system shown in FIG. 3 in that, no air gap is disposed in the optical system shown in FIG. 14. It may be understood that, in addition to the foregoing differences, there may also be other differences between FIG. 10 to FIG. 14 and FIG. 3, and there may alternatively be no difference. This is not limited in the present disclosure. The following describes, in detail, the optical systems in different examples in FIG. 3 and FIG. 10 to FIG. 14.

With reference to FIG. 3, in some examples, the metasurface 130 is disposed on the fourth surface 104, and the fourth surface 104 is a plane. With reference to FIG. 10, the metasurface 130 is disposed on the fourth surface 104, and an absolute value of a curvature radius of the fourth surface 104 is greater than 100 millimeters. The curvature radius of the fourth surface 104 is set to be relatively large, that is, the fourth surface 104 is constructed as a micro-curved surface approximating a plane, to facilitate attachment of the metasurface 130. It may be understood that, FIG. 10 schematically shows a case in which the fourth surface 104 is a concave surface, but the present disclosure is not limited thereto. The fourth surface may alternatively be a convex surface whose curvature radius has an absolute value greater than 100 millimeters.

With reference to FIG. 11, in some examples, the metasurface 130 is disposed on the third surface 103, and an absolute value of a curvature radius of the third surface 103 is greater than 100 millimeters. The curvature radius of the third surface 103 is set to be relatively large, that is, the third surface 103 is constructed as a micro-curved surface approximating a plane, to facilitate attachment of the metasurface 130.

With reference to FIG. 12, in some examples, the metasurface 130 is disposed on the third surface 103, and the third surface 103 is a plane.

For example, the third surface and the fourth surface may both be planes (with reference to FIG. 12), or may both be micro-curved surfaces. For example, the third surface and the fourth surface may both be convex surfaces, or may both be concave surfaces. For example, one of the third surface and the fourth surface may be a convex surface, and the other one may be a concave surface, as long as attachment of the metasurface can be facilitated. This is not limited in the present disclosure.

With reference to FIG. 13, in some examples, the lens assembly 100 includes the first lens 110 and the second lens 120. The first lens 110 includes the first surface 101 and the second surface 102. The second lens 120 includes the third surface 103 and the fourth surface 104. The metasurface 130 is disposed on the fourth surface 104. The optical system further includes an adhesive layer 700, where the adhesive layer 700 is glued between the second surface 102 and the third surface 103, to improve compactness of the optical system. As shown in FIG. 13, a surface on one side of the adhesive layer 700 may be glued on the third surface 103, and a surface on the other side may be glued on the linear polarizing film 500.

For example, with reference to FIG. 13, the second surface 102 is a concave surface, the third surface 103 is a convex surface, and the second surface 102 and the third surface 103 have the same surface type parameters. For example, when no other film layer is disposed between the second surface 102 and the third surface 103, the second surface 102 and the third surface 103 may be substantially completely attached to each other without a gap.

With reference to FIG. 14, in some examples, the lens assembly 100 includes the first lens 110, the second lens 120, and a third lens 140. The first lens 110 includes the first surface 101, the second lens 120 includes the second surface 102, and the third lens 140 includes the third surface 103 and the fourth surface 104. The first lens 110 further includes a fifth surface 105 disposed opposite to the first surface 101, the second lens 120 further includes a sixth surface 106 disposed opposite to the second surface 102, and the fifth surface 105 is located between the first surface 101 and the sixth surface 106. Therefore, by introducing the fifth surface 105 and the sixth surface 106, it is possible to provide more attachment positions for an optical film layer (for example, for the first phase retardation film 400) in the optical system. The fifth surface 105 and the sixth surface 106 are both planes. The first phase retardation film 400 is disposed on one of the fifth surface 105 and the sixth surface 106. Therefore, the processing process of the fifth surface 105 and the sixth surface 106 can be simplified, to prevent wrinkles from occurring when the first phase retardation film 400 is attached. It may be understood that, when the first phase retardation film is attached, the first phase retardation film may be attached on the fifth surface, or may be attached on the sixth surface. This is not limited in the present disclosure.

In some other examples, the fifth surface and the sixth surface may alternatively be set as curved surfaces having same surface type parameters, and absolute values of curvature radiuses of the curved surfaces are greater than 100 millimeters. The curvature radiuses of the fifth surface and the sixth surface are set to be relatively large, so that the fifth surface and the sixth surface are constructed as micro-curved surfaces approximating planes, to facilitate attachment of the first phase retardation film.

The following describes a glasses lens that can meet visual clarity to objects at different distances provided in the present disclosure.

FIG. 15 is a schematic diagram of a progressive addition lens.

With reference to FIG. 15, the progressive addition lens includes a far visual acuity area Q1, a near visual acuity area Q2, and a medium visual acuity area Q3 located between the far visual acuity area Q1 and the near visual acuity area Q2. The far visual acuity area Q1, the near visual acuity area Q2, and the medium visual acuity area Q3 respectively have different focuses, so as to meet visual acuity correction requirements of users who have both nearsightedness and farsightedness (or who have both nearsightedness and presbyopia), so that the user can achieve visual clarity in long, medium, and short distances, and do not need to switch glasses with different degrees in different scenarios.

In researches, the inventor of this application finds that, although a plurality of areas with different focuses are disposed on the progressive addition lens to adapt to requirements for visual clarity at difference distances, an obvious focal power step exists at a boundary junction between areas, affecting wear experience of the user, for example, affecting clarity or causing asthenopia or dizziness of the user. In addition, the progressive addition lens also has astigmatic area located on two sides of the progressive addition lens. The user feels blurred or distortion when watching an object by using the astigmatic area located on an edge, which leads to the difficulty of user adaptation and limited vision.

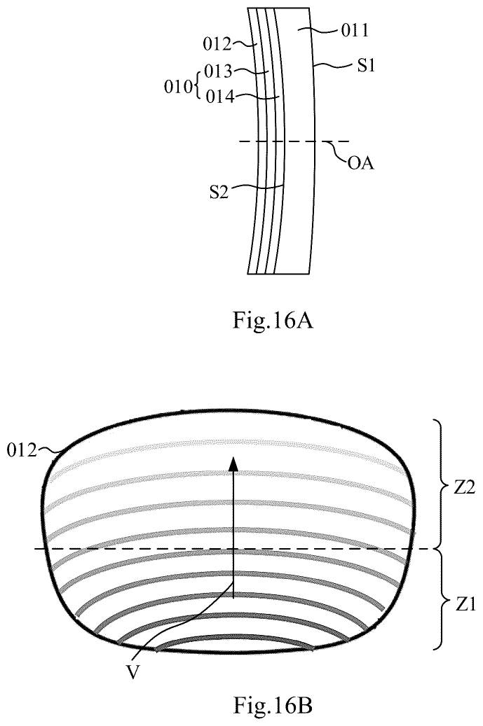

FIG. 16A is a schematic diagram of a glasses lens according to an example in at least one embodiment of the present disclosure; and FIG. 16B is a schematic diagram of a metasurface of the glasses lens shown in FIG. 16A.

With reference to FIG. 16A and FIG. 16B, the glasses lens includes a lens body 011, a metasurface 012, and a polarizing element 010. The lens body 011 includes a first lens surface S1 and a second lens surface S2 that are disposed opposite to each other in a direction of an optical axis OA of the lens body 011, and the metasurface 012 is disposed on a side of the second lens surface S2 away from the first lens surface S1. The polarizing element 010 is disposed on a light incident side of the metasurface 012, and is configured to regulate a polarization state of light, to improve a manipulation capability of the metasurface 012 for light incident onto the metasurface 012. For example, the polarizing element 010 can change natural light into circularly polarized light after regulating the natural light, then the circularly polarized light is incident onto the metasurface 012, and the light is converged or diverged according to actual requirements. FIG. 16A schematically shows a case in which the first lens surface is a convex surface and the second lens surface is a concave surface, but the present application is not limited thereto. The first lens surface and the second lens surface may alternatively both be planes, the first lens surface may alternatively be a concave surface, and the second lens surface may alternatively be a convex surface. For example, the optical axis OA may be an optical center line of the lens body 011. For example, the second lens surface S2 is a near-eye side lens surface of the glasses lens. Certainly, the second lens surface may alternatively be a far-eye side lens surface of the glasses lens. This is not limited in the present disclosure.

With reference to FIG. 16A and FIG. 16B, the metasurface 012 includes a first area Z1 and a second area Z2 located on one side of the first area Z1. In an arrangement direction V of the first area Z1 and the second area Z2, the focal power of the metasurface 012 gradually decreases. For example, when a user uses the glasses lens, the arrangement direction V of the first area Z1 and the second area Z2 is perpendicular to a central connecting line of two eyes of the user. Thereby, by setting the metasurface 012 to have gradually changing focal power, a sudden change in imaging definition can be prevented while requirements of the user for visual clarity to objects at different distances can be met, and an astigmatic area or a blind area does not appear. In addition, by providing the metasurface 012, it also possible to make a thickness of the lens body 011 to be smaller, so that the lens body 011 is lighter and thinner. For example, the user can meet a long-distance visual clarity requirement by using a side of the second area Z2 away from the first area Z1, and meet a short-distance visual clarity requirement by using a side of the first area Z1 away from the second area Z2.

With reference to FIG. 16B, for example, the arrangement direction V of the first area Z1 and the second area Z2 may be parallel to an up-down direction in FIG. 16B, and the first area Z1 may be located below the second area Z2. For example, in the arrangement direction V of the first area Z1 and the second area Z2, the focal power of the metasurface 012 may continuously decrease. Certainly, gradual decrease of the focal power may alternatively be regional decrease, and this is not limited in the present disclosure.

For example, the metasurface includes a liquid crystal layer, the liquid crystal layer includes liquid crystal modules in a cholesteric phase with a particular pitch. In the liquid crystal layer, a pitch of liquid crystal molecules located in any area of the first area is greater than a pitch of liquid crystal modules located in any area of the second area. Certainly, in other examples, the metasurface may alternatively implement a gradual change of focal power in another manner. For example, a micro-nano structure may be disposed in the first area and the second area. The micro-nano structure may be a nano-pillar. By changing a size, a shape, and a deflection angle of the nano-pillar, different areas have different focal power.

For example, with reference to FIG. 16A, the polarizing element 010 includes a phase retardation film 013 and a linear polarizing film 014, the phase retardation film 013 and the linear polarizing film 014 are both located on the side of the second lens surface S2 away from the first lens surface S1, the phase retardation film 013 is located between the linear polarizing film 014 and the metasurface 012, and the metasurface 012 is located on a light emitting side of the phase retardation film 013 and is configured to regulate light incident onto the metasurface 012. Natural light is changed into linearly polarized light after passing through the linear polarizing film 014. The linearly polarized light is changed into left circularly polarized light or right circularly polarized light after passing through the phase retardation film 013. Then, the metasurface 012 regulates a polarization state of the left circularly polarized light or the right circularly polarized light, to convergence or divergence of light.

For example, with reference to FIG. 16A, the second lens surface S2 may be a near-eye side lens surface, the linear polarizing film 014 is disposed on the second lens surface S2, and the phase retardation film 013 is located between the metasurface 012 and the linear polarizing film 014, so that light sequentially passes through the lens body 011, the linear polarizing film 014, the phase retardation film 013, and the metasurface 012, and then is incident onto human eyes. Certainly, the second lens surface, the linear polarizing film, the phase retardation film, and the metasurface may alternatively be located on a far-eye side, as long as the light can sequentially pass through the linear polarizing film, the phase retardation film, and the metasurface and then be incident onto human eyes after being regulated by the metasurface. This is not limited in the present disclosure.

The following describes a glasses lens that can correct astigmatism provided in the present disclosure.

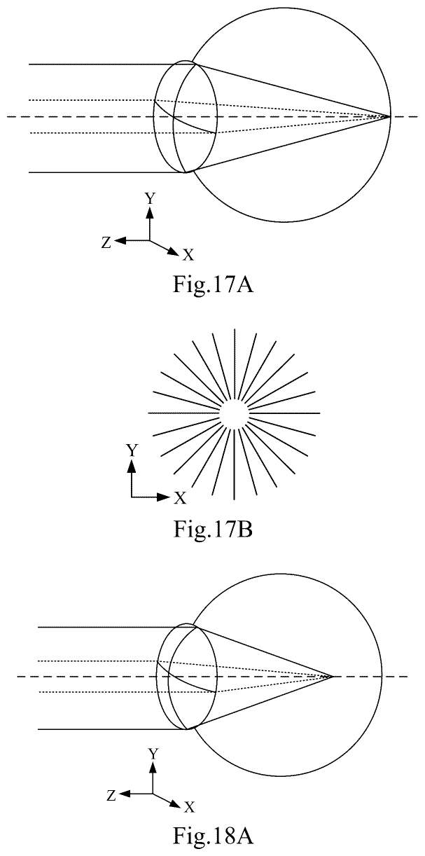

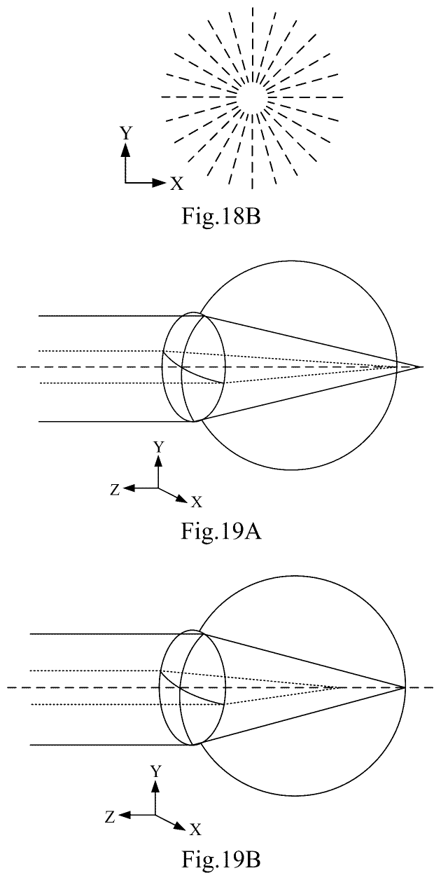

FIG. 17A is a schematic cross-sectional view of an eyeball with normal visual acuity; FIG. 17B is a diagram of an astigmatism test of normal visual acuity; FIG. 18A is a schematic cross-sectional view of an eyeball with nearsightedness and without astigmatism; and FIG. 18B is a diagram of an astigmatism test with nearsightedness and without astigmatism.

As shown in FIG. 17A, in normal visual acuity, light entering an eye can all be focused on a retina, and as shown in FIG. 17B, focusing capabilities of the eye in different directions are the same, so that a clear image can be formed. As shown in FIG. 18A, in the case of nearsightedness, light entering the eye is focused in front of the retina, making a distant object look blurred. As shown in FIG. 18B, in the case of without astigmatism, blurring degrees of the eye in different directions also tend to be consistent. In the case of nearsightedness without astigmatism, visual acuity can be corrected by wearing nearsighted glasses, and an astigmatism test diagram after correction may be consistent with FIG. 17B.

Different from nearsightedness, astigmatism is another state of ametropia of eyes. Astigmatism is mainly caused by inconsistencies between focusing power or refractive power of a meridian plane and a sagittal plane of the eyeball. Specifically, an eyeball in a normal state is a rotationally symmetric sphere around a Z-axis, but when a shape of the eyeball is abnormal, the shape of the eyeball is deformed into an ellipsoid or a more complex non-rotationally symmetric shape, causing a failure to focus light at a same position, resulting in blurred lines of sight.

Astigmatism is classified into two main categories: regular astigmatism and irregular astigmatism. In the case of regular astigmatism, deformation of the eyeball follows a certain law, and may be corrected by an astigmatic lens such as a lenticular lens. In the case of irregular astigmatism, deformation of the eye is more complex, making correction more difficult.

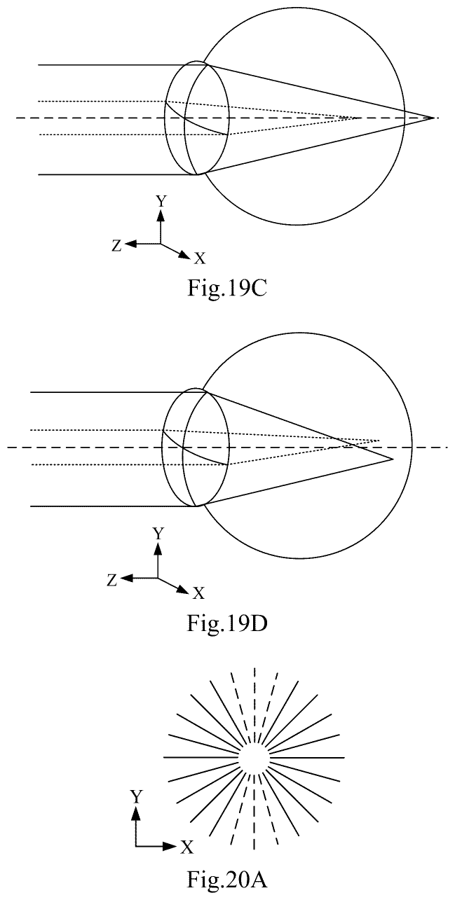

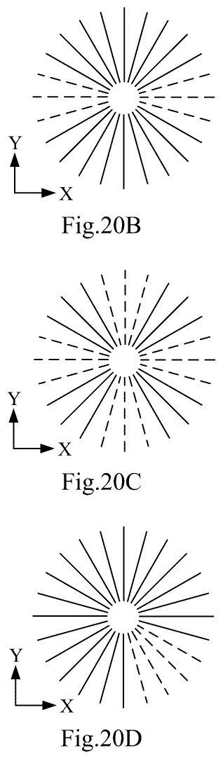

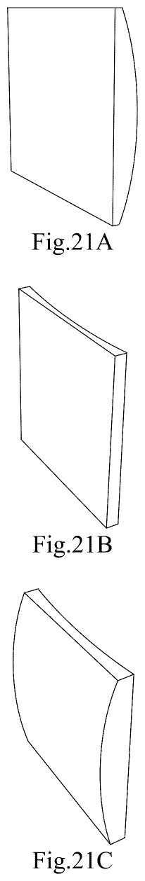

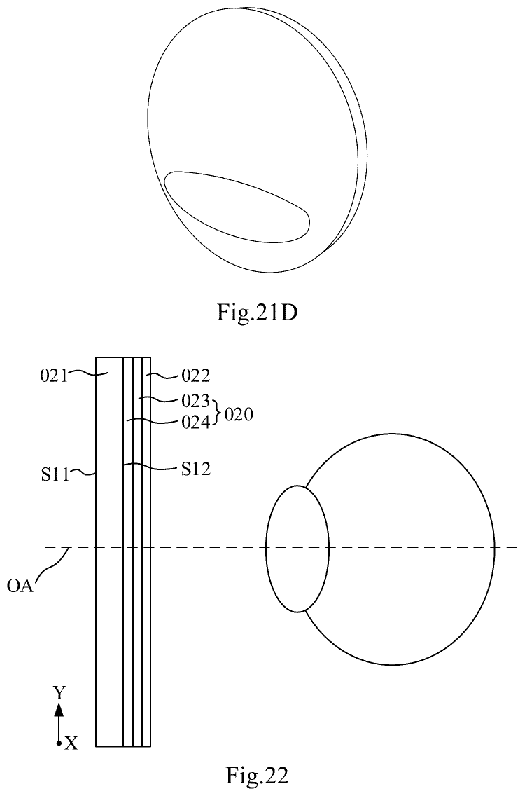

FIG. 19A to FIG. 19D are schematic cross-sectional views of eyeballs with different types of astigmatism; FIG. 20A to FIG. 20D are diagrams of astigmatism tests of different types of astigmatism; and FIG. 21A to FIG. 21D show astigmatic lenses for correcting different types of astigmatism.

As shown in FIG. 19A, light of the sagittal plane (the XZ plane) can be focused on the retina, but light of the meridian plane (the YZ plane) cannot be focused on the retina. As shown in FIG. 20A, eyes are blurred in the Y direction. In this regard, with reference to FIG. 21A, a lenticular lens having a curved surface in the Y direction may be used, so that the light of the meridian plane is focused on the retina, and light in the Y direction perpendicular to the X direction is not affected. Therefore, an astigmatism test diagram after correction by using the lenticular lens shown in FIG. 21A may be consistent with FIG. 17B.

As shown in FIG. 19B, light of the meridian plane (the YZ plane) can be focused on the retina, but light of the sagittal plane (the XZ plane) cannot be focused on the retina. As shown in FIG. 20B, eyes are blurred in the X direction. In this regard, with reference to FIG. 21B, a lenticular lens having a curved surface in the X direction may be used, so that the light of the sagittal plane is focused on the retina, and light in the X direction is not affected. Therefore, an astigmatism test diagram after correction by using the lenticular lens shown in FIG. 21B may be consistent with FIG. 17B.

As shown in FIG. 19C, neither light of the sagittal plane (the XZ plane) nor light of the meridian plane (the YZ plane) can be focused on the retina. As shown in FIG. 20C, eyes are blurred in the X direction and the Y direction. In this regard, with reference to FIG. 21C, a lenticular lens having a curved surface in both the X direction and the Y direction may be used, so that light of both the meridian plane and the meridian plane is focused on the retina. Therefore, an astigmatism test diagram after correction by using the lenticular lens shown in FIG. 21C may be consistent with FIG. 17B.

In addition to the cases of regular astigmatism shown in FIG. 19A to FIG. 19C, FIG. 19D and FIG. 20D further show cases of irregular astigmatism. As shown in FIG. 19D, neither light of the sagittal plane (the XZ plane) nor light of the meridian plane (the YZ plane) can be focused on the retina, and a light focus of the sagittal plane and a light focus of the meridian plane both deviate from an optical axis. As shown in FIG. 20D, eyes are blurred in an area between the X direction and the Y direction. In this regard, with reference to FIG. 21D, a corneal contact lens with a toric lens may be used. The corneal contact lens may be a non-rotationally symmetric lens. For example, surfaces of the corneal contact lens have different curvature radiuses in two directions perpendicular to each other. For example, the corneal contact lens may also be designed to have different thicknesses in different areas. Therefore, the corneal contact lens corresponds to different focal power in different areas, so that the corneal contact lens can correct light in different dimensions, and focus all the light onto the retina. Therefore, an astigmatism test diagram after correction by using the lenticular lens shown in FIG. 21D may be consistent with FIG. 17B.

In researches, the inventor of this application finds through research that, the foregoing manner of correcting astigmatism in different cases by using the lenticular lens usually causes a defect that the glasses are excessively thick, or a problem that a processing difficultly is high (with reference to the toric lens shown in FIG. 21D).

FIG. 22 is a schematic diagram of a glasses lens according to an example in at least one embodiment of the present disclosure. FIG. 22 schematically shows that a first direction X is a direction perpendicular to paper, and the first direction X is perpendicular to a second direction Y, but this is not limited in the present disclosure. The first direction and the second direction may alternatively intersect with each other and are not perpendicular to each other.

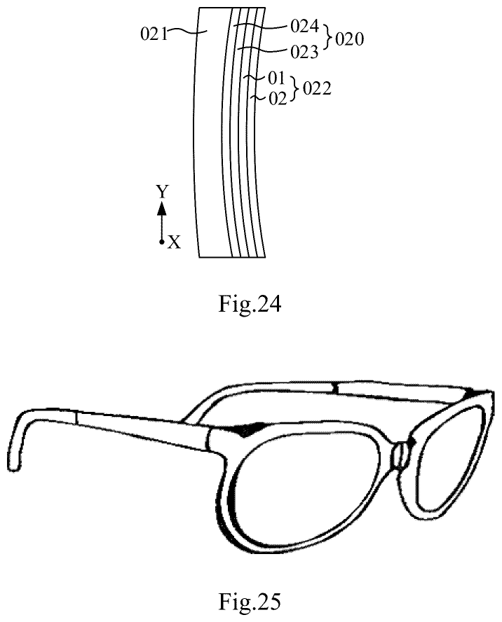

With reference to FIG. 22, the glasses lens includes a lens body 021, a metasurface 022, and a polarizing element 020. The lens body 021 includes a first lens surface S11 and a second lens surface S12 that are disposed opposite to each other in a direction of an optical axis OA of the lens body 021. For example, when the glasses lens is used, the first lens surface and the second lens surface are perpendicular to the ground. FIG. 22 schematically shows a case in which the first lens surface S11 and the second lens surface S12 are both planes, but the present application is not limited thereto. The first lens surface and the second lens surface may alternatively be curved surfaces (for example, with reference to FIG. 24 in the subsequent examples).

For example, with reference to FIG. 22, the optical axis OA may be an optical center line of the lens body 021. The metasurface 022 is disposed on a side of the second lens surface S12 away from the first lens surface S11. The polarizing element 020 is disposed on a light incident side of the metasurface 022, and is configured to regulate a polarization state of light, to improve a manipulation capability of the metasurface 022 for light incident onto the metasurface 022. For example, the polarizing element 020 can change natural light into circularly polarized light after regulating the natural light, then the circularly polarized light is incident onto the metasurface 022, and the light is converged or diverged according to actual requirements. The focal power of the metasurface 022 in the first direction X is different from the focal power of the metasurface 022 in the second direction Y, where the first direction X and the second direction Y intersect with each other, and are respectively tangential to the second lens surface S12. The metasurface 022 has different focal power in different directions, to accurately correct different cases of astigmatism. In addition, by providing the metasurface 022, it is also possible to make the lens body 021 lighter and thinner.

For example, the first direction and the second direction may both be adaptively adjusted according to use requirements of the user. For example, a metasurface matching a use requirement of the user may be designed by considering parameters such as axial lengths of eyeballs of the user. For example, there may be an included angle of 0° to 90° between the first direction and the second direction. For example, the included angle may be 30° to 75, 45° to 60°, or 20° to 80°, but the present disclosure is not limited thereto.

For example, with reference to FIG. 22, the polarizing element 020 includes a phase retardation film 023 and a linear polarizing film 024, the phase retardation film 023 and the linear polarizing film 024 are both located on the side of the second lens surface S12 away from the first lens surface S11, the phase retardation film 023 is located between the linear polarizing film 024 and the metasurface 022, and the metasurface 022 is located on a light emitting side of the phase retardation film 023 and is configured to regulate light incident onto the metasurface 022. Natural light is changed into linearly polarized light after passing through the linear polarizing film 024. The linearly polarized light is changed into left circularly polarized light or right circularly polarized light after passing through the phase retardation film 023. Then, the metasurface 022 regulates a polarization state of the left circularly polarized light or the right circularly polarized light, to realize convergence or divergence of light.

For example, FIG. 22 schematically shows a schematic diagram in which the second lens surface S12, the linear polarizing film 024, the phase retardation film 023, and the metasurface 022 are located on the near-eye side, but the present disclosure is not limited thereto. The second lens surface, the linear polarizing film, the phase retardation film, and the metasurface may alternatively be located on a far-eye side, as long as the light can sequentially pass through the linear polarizing film, the phase retardation film, and the metasurface and then be incident onto human eyes after being regulated by the metasurface. This is not limited in the present disclosure.

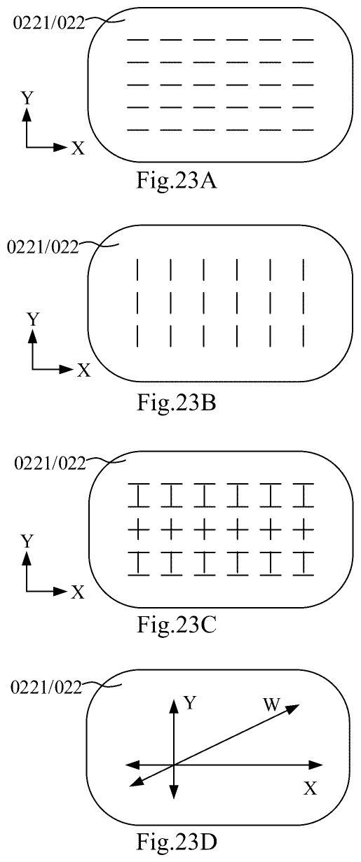

FIG. 23A to FIG. 23D are schematic diagrams of metasurfaces according to different examples in at least one embodiment of the present disclosure. FIG. 23A to FIG. 23D may be the metasurface in the glasses lens shown in FIG. 22, but this not limited in the present disclosure.

For example, the metasurface 022 includes a liquid crystal layer 0221. With reference to FIG. 23A, a long-axis direction of liquid crystal molecules in the liquid crystal layer 0221 is parallel to the X direction, so that the metasurface 022 has a convergence capability in a YZ plane, and has no convergence capability in an XZ plane. Therefore, the metasurface 022 shown in FIG. 23A can replace the lenticular lens shown in FIG. 21A, to correct the cases of astigmatism shown in FIG. 19A and FIG. 20A.

With reference to FIG. 23B, the long-axis direction of the liquid crystal molecules in the liquid crystal layer 0221 is parallel to the Y direction, so that the metasurface 022 has a convergence capability in the XZ plane, and has no convergence capability in the YZ plane. Therefore, the metasurface 022 shown in FIG. 23B can replace the lenticular lens shown in FIG. 21B, to correct the cases of astigmatism shown in FIG. 19B and FIG. 20B.

FIG. 24 is a schematic diagram of a glasses lens using the metasurface shown in FIG. 23C.

Two metasurfaces may be disposed, and one metasurface includes one liquid crystal layer, or one metasurface may include two liquid crystal layers. An example in which one metasurface includes two liquid crystal layers is used for illustration. With reference to FIG. 23C and FIG. 24, long axes of liquid crystal molecules in a liquid crystal layer 01 and a liquid crystal layer 02 are both parallel to an XY plane, and there is an included angle between the long axes of the liquid crystal molecules in the liquid crystal layer 01 and the liquid crystal layer 02. For example, the long-axis direction of the liquid crystal molecules in the liquid crystal layer 01 is parallel to the X direction, and the long-axis direction of the liquid crystal molecules in the liquid crystal layer 02 is parallel to the Y direction, so that the metasurface 022 has convergence capabilities in both the XZ plane and the YZ plane. Therefore, the metasurface 022 shown in FIG. 23C can replace the lenticular lens shown in FIG. 21C, to correct the cases of astigmatism shown in FIG. 19C and FIG. 20C. Certainly, in other cases of astigmatism (for example, cases of astigmatism distributed in an orange section shape), by providing a plurality of metasurfaces with liquid crystal layers of different liquid crystal orientations, and by setting rotation angles between the plurality of metasurfaces, different cases of astigmatism are flexibly corrected. This is not limited in the present disclosure.

With reference to FIG. 23D, more than two liquid crystal layers may alternatively be disposed, and long axes of liquid crystal molecules of different liquid crystal layers are all parallel to the XY plane and there is an included angle between every two long axes. For example, long axes of liquid crystal molecules in different liquid crystal layers in FIG. 23D may be respectively parallel to the X direction, the Y direction, and the W direction. For example, included angles of 0° to 90° may respectively exist between every two of the X direction, the Y direction, and the W direction. For example, the included angle may be 30° to 75, 45° to 60°, or 20° to 80°, but the present disclosure is not limited thereto. In addition, different liquid crystal layers may alternatively be eccentrically disposed, to achieve an optical effect equivalent to that of the toric lens, so as to perform correction on an irregular chromatic aberration. Therefore, the metasurface shown in FIG. 23D can replace the lenticular lens shown in FIG. 21D, to correct the cases of astigmatism shown in FIG. 19D and FIG. 20D.

FIG. 25 is a schematic diagram of glasses according to at least one embodiment of the present disclosure.

With reference to FIG. 25, the glasses may include the glasses lens in any one of the foregoing examples. Because the glasses according to embodiments of the present disclosure use the foregoing glasses lens, the glasses also have the corresponding beneficial technical effect, and details are not described herein again.

The following needs to be described:

(1) The accompanying drawings of embodiments of the present disclosure only relate to structures involved in embodiments of the present disclosure, and reference may be made to common designs for other structures.

(2) If there is no conflict, features in a same embodiment and in different embodiments of the present disclosure may be combined with each other.

The foregoing is merely exemplary implementations of the present disclosure, and is not intended to limit the protection scope of the present disclosure. The protection scope of the present disclosure is determined by the appended claims.

1. An optical system, comprising:
a lens assembly, comprising at least two lenses, wherein the at least two lenses comprise a first surface, a second surface, a third surface, and a fourth surface that are sequentially arranged in a direction of an optical axis of the lens assembly, and the first surface is a convex surface;
a transflective film, located on a side of the first surface away from the second surface;
a polarizing reflective layer, located on a side of the second surface away from the first surface; and
a first phase retardation film, located on a side of the first surface away from the transflective film, wherein the lens assembly further comprises a metasurface, the metasurface is located on the side of the second surface away from the first surface, and the metasurface is located on a light emitting side of the polarizing reflective layer; and
the metasurface comprises a first area and a second area surrounding at least part of the first area, and a focal power of the first area is less than a focal power of the second area.

2. The optical system according to claim 1, wherein the metasurface comprises a liquid crystal layer, and in the liquid crystal layer, a pitch of liquid crystal molecules located in any area of the first area is greater than a pitch of liquid crystal molecules located in any area of the second area.

3. The optical system according to claim 1, wherein a focal power of the metasurface gradually increases in a direction from a center of the first area to an edge of the first area.

4. The optical system according to claim 3, wherein the focal power of the first area is 0.

5. The optical system according to claim 1, wherein the focal power of the metasurface in different areas of the first area is equal, and the focal power of the metasurface in different areas of the second area is equal.

6. The optical system according to claim 1, wherein the optical axis of the lens assembly runs through the first area.

7. The optical system according to claim 1, further comprising a linear polarizing film located between the second surface and the third surface, wherein
the polarizing reflective layer and the first phase retardation film are both located between the linear polarizing film and the first surface.

8. The optical system according to claim 7, further comprising a second phase retardation film, located between the linear polarizing film and the metasurface and configured to regulate light incident onto the metasurface.

9. The optical system according to claim 1, wherein the metasurface is disposed on the fourth surface, the fourth surface is a plane, or an absolute value of a curvature radius of the fourth surface is greater than 100 millimeters.

10. The optical system according to claim 1, wherein the metasurface is disposed on the third surface, the third surface is a plane, or an absolute value of a curvature radius of the third surface is greater than 100 millimeters.

11. The optical system according to claim 1, wherein the lens assembly comprises a first lens and a second lens;
the first lens comprises the first surface and the second surface, the second lens comprises the third surface and the fourth surface, and the metasurface is disposed on the fourth surface; and
the second surface is a concave surface, the third surface is a concave surface or a plane, and there is an air gap between the first lens and the second lens.

12. The optical system according to claim 11, wherein the optical system comprises a first optical assembly and a second optical assembly;
the first optical assembly comprises the first lens, the transflective film, the polarizing reflective layer, and the first phase retardation film;
the second optical assembly comprises the second lens and the metasurface; and
a ratio of a focal power of the first optical assembly to a focal power of the second optical assembly ranges from 50 to 90.

13. The optical system according to claim 1, wherein the lens assembly comprises a first lens and a second lens;
the first lens comprises the first surface and the second surface, the second lens comprises the third surface and the fourth surface, and the metasurface is disposed on the fourth surface;
the optical system further comprises an adhesive layer, wherein the adhesive layer is glued between the second surface and the third surface; and
the second surface is a concave surface, the third surface is a convex surface, and the second surface and the third surface have same surface type parameters.

14. The optical system according to claim 1, wherein the lens assembly comprises a first lens, a second lens, and a third lens;
the first lens comprises the first surface, the second lens comprises the second surface, and the third lens comprises the third surface and the fourth surface; and the first lens further comprises a fifth surface disposed opposite to the first surface, the second lens further comprises a sixth surface disposed opposite to the second surface, and the fifth surface is located between the first surface and the sixth surface; and
the fifth surface and the sixth surface are both planes, and the first phase retardation film is disposed on one of the fifth surface and the sixth surface.

15. A display apparatus, comprising:
a display screen, comprising a display surface; and
the optical system according to claim 1,
wherein the display surface is located on a side of the first surface away from the second surface, and an orthographic projection of the display surface on the metasurface overlaps the first area.

16. A glasses lens, comprising:
a lens body, comprising a first lens surface and a second lens surface that are disposed opposite to each other in a direction of an optical axis of the lens body;
a metasurface, disposed on a side of the second lens surface away from the first lens surface; and
a polarizing element, disposed on a light incident side of the metasurface, and configured to regulate a polarization state of light,
wherein the metasurface comprises a first area and a second area located on one side of the first area, and
a focal power of the metasurface gradually decreases in an arrangement direction of the first area and the second area.

17. The glasses lens according to claim 16, wherein the polarizing element comprises a phase retardation film and a linear polarizing film, the phase retardation film and the linear polarizing film are both located on the side the second lens surface away from the first lens surface, the phase retardation film is located between the linear polarizing film and the metasurface, and the metasurface is located on a light emitting side of the phase retardation film and is configured to regulate light incident onto the metasurface.

18. A glasses lens, comprising:
a lens body, comprising a first lens surface and a second lens surface that are disposed opposite to each other in a direction of an optical axis of the lens body;
a metasurface, disposed on a side of the second lens surface away from the first lens surface; and
a polarizing element, disposed on a light incident side of the metasurface, and configured to regulate a polarization state of light,
wherein a focal power of the metasurface in a first direction is different from a focal power of the metasurface in a second direction, the first direction and the second direction intersect with each other, and are respectively tangential to the second lens surface.

19. The glasses lens according to claim 18, wherein the polarizing element comprises a phase retardation film and a linear polarizing film, the phase retardation film and the linear polarizing film are both located on the side the second lens surface away from the first lens surface, the phase retardation film is located between the linear polarizing film and the metasurface, and the metasurface is located on a light emitting side of the phase retardation film and is configured to regulate light incident onto the metasurface.

20. Glasses, comprising the glasses lens according to claim 16.
